(19) United States
(12) Patent Application Publication
(10) Pub. No.: US 2013/0081969 A1
(43) Pub. Date: Apr. 4, 2013

(54) APPARATUS FOR SECURING AN ELECTRONIC DEVICE IN A COVER

(71) Applicants: Joshua T. Morenstein, San Francisco, CA (US); Noah Murphy-Reinhertz, San Francisco, CA (US); Nick Cronan, Oakland, CA (US); Dan Snyder, San Francisco, CA (US); Isabelle Olson, San Francisco, CA (US)

(72) Inventors: Joshua T. Morenstein, San Francisco, CA (US); Noah Murphy-Reinhertz, San Francisco, CA (US); Nick Cronan, Oakland, CA (US); Dan Snyder, San Francisco, CA (US); Isabelle Olson, San Francisco, CA (US)

(21) Appl. No.: 13/249,153

(22) Filed: Sep. 29, 2011

(51) Int. Cl. B65D 67/02; F16B 2/22; F16B 2/06

(52) U.S. Cl. 206/480; 248/226.11; 248/231.81

(57) ABSTRACT

An apparatus for securing an electronic device to a cover. The apparatus is in the form of a clip that uses a 3-point system to provide a secure hold on a device without requiring any holes in the device. Three contact points radiate from a main body in a triangular fashion in plan view. Two of the contact points are formed as cups that couple with two respective corners of the electronic device. The third contact point is an elastically deformable clip that engages a side or top of the electronic device.

### FIELD OF THE INVENTION

The present invention generally relates to covers for electronic devices, and more particularly to an apparatus for securing an electronic device to a cover.

### BACKGROUND OF THE INVENTION

With the advent of “electronic paper” and new liquid crystal display (LCD) technology that allows easy reading of electronic documents in varying light conditions with limited power, electronic book or tablet devices such as the Barnes & Noble Nook®, have hit the mainstream. The technology has quickly evolved to very thin, portable devices that have long battery life and built in communication such as cellular or wireless. Many people are beginning to use these devices like they would ordinary books, magazines, or newspapers, carrying them in briefcases or beach bags like they would an ordinary paper periodical or book.

There are many types of book or device covers that offer different levels of flexibility or levels of convenience in providing functionality as a cover for the device as well as acting as a stand or easel for hands free viewing of the device. One issue facing designers of such covers or stands is how to secure the electronic device to cover or stand. Some prior art apparatuses have included protrusions formed in the cover that mate with apertures in the electronic device. Other apparatuses provide pockets formed on a surface of the cover in which the electronic device can be received. Some have provided flexible elastic straps that fit over portions of the electronic device, for example the corners of the device.

None of these conventional apparatuses provide a simple mechanism for mounting and un-mounting the electronic device to the cover while at the same time providing a secure coupling of the device to the cover.

### SUMMARY OF THE INVENTION

The present invention is an apparatus for securing an electronic device to a cover.

The apparatus is in the form of a clip that uses a 3-point system to provide a secure hold on a device without requiring any holes in the device. The clip also provides an improved user experience in attaching and detaching an electronic device from the clip.

The three contact points radiate from a main body in a triangular fashion in plan view. Two of the contact points are formed as cups that couple with two respective corners of the electronic device. The third contact point is an elastically deformable clip that engages a side of the electronic device.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 is a perspective view of the securing apparatus;

FIG. 2 is a plan view of the securing apparatus;

FIG. 3 is a bottom view of the securing apparatus with an electronic device attached thereto;

FIG. 4 is a top view of the securing apparatus with the electronic device attached thereto;

FIG. 5 is a side view of the elastic clip contact point;

FIG. 6 is a perspective view of one of the corner contact points; and

FIG. 7 illustrates the securing apparatus of the present invention embedded in a cover for an electronic device.

### DETAILED DESCRIPTION OF THE INVENTION

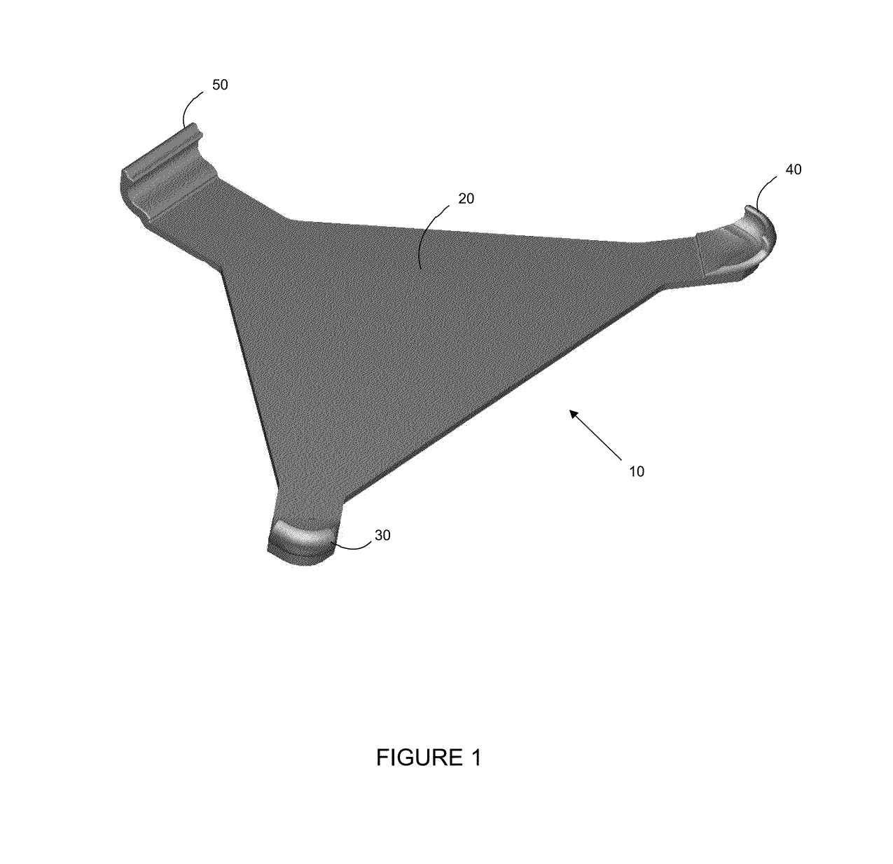

FIG. 1 is a perspective view of the securing apparatus 10 of the present invention. The clip 10 has a main body 20, two corner cups 30, 40 and an elastically deformable clip 50. In a preferred embodiment, the clip 10 is formed of a plastic material. As seen in this Figure, the basic shape of securing apparatus 10 is triangular, due to the three point connection design of the apparatus 10.

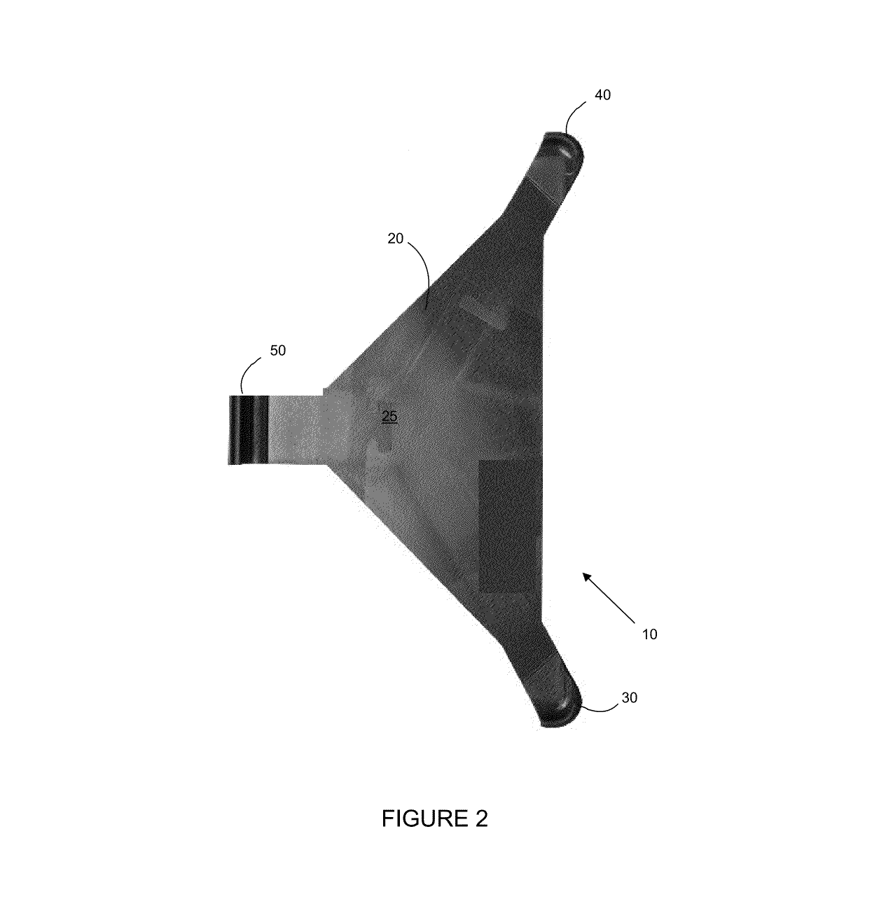

FIG. 2 is a plan view of the top of securing apparatus 10. As seen in this view, the surface 25 of body 20 is the portion of securing device 10 that faces and supports the electronic device when the device is mounted in the apparatus 10.

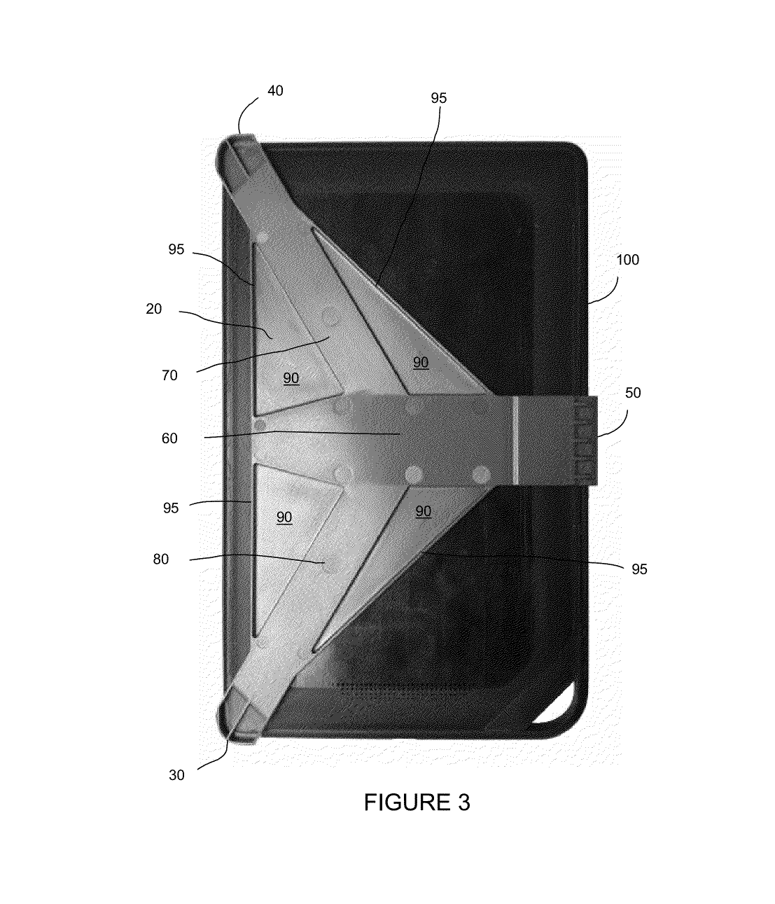

FIG. 3 is a bottom view of the securing apparatus 10 with an electronic device 100 attached thereto. This figure clearly shows the triangular or “Y” shaped structure of apparatus 10. Elastically deformable clip 50 is connected to body 20 by main member 60. Contact points 30 and 40 are respectively connected to body 20 by connecting members 80 and 70. As seen in this Figure, main member 60 is wider than connecting members 70 and 80 and provides a substantial amount of the support and rigidity of apparatus 10. Additionally, as the user operates elastically deformable clip 50 in order to attach and detach electronic device 100, it is preferable that main member 60 have additional structure to enable many thousands of cycles of attachment and detachment of electronic device 100.

In addition to the main member 60 and connecting members 70 and 80, it is preferable that web members 90 and ribs 95 are formed in body 20 to provide additional support and rigidity to apparatus 10.

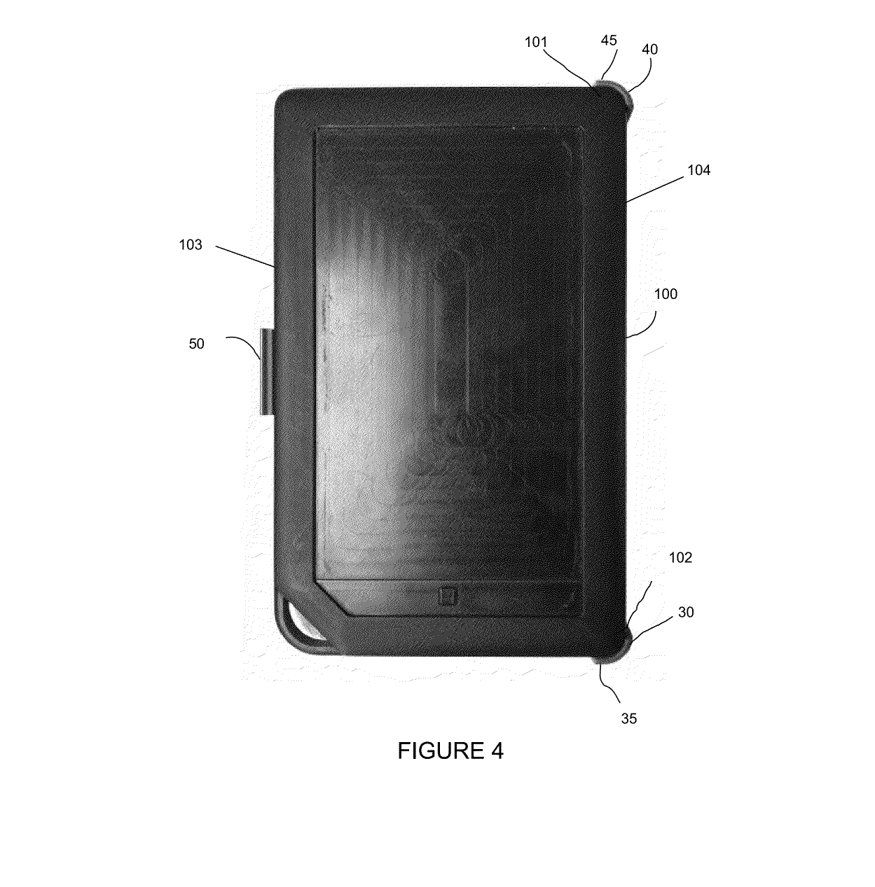

FIG. 4 is a top view of the securing apparatus 10 with the electronic device 100 attached thereto. As shown in this Figure, contact points 30 and 40 are operably connected to two corners 101, 102 of the electronic device 100, while the main elastically deformable clip 50 is engaged with device 100 along the middle of an opposing side 103. As shown in this Figure, in order to provide sufficient stability and holding power, it is preferable to engage the device 100 with the corner contacts points 30, 40 along one long side 104 of the device 100 and engage the device 100 with the clip 50 along the other long side 103 of the device. Although the two corners and the middle of the shorter sides can be used as the engagement points of the apparatus 10, the present inventors have determined this configuration does not provide as much stability and holding strength as engaging the longer sides 103, 104 or electronic device 100.

The distance between the far end 35 of contact point 30 and the far end 45 of contact point 45 is such that when a user inserts electronic device 100 into securing apparatus 10 (as further described below) there is a pressure fit between the two contact points 30, 40.

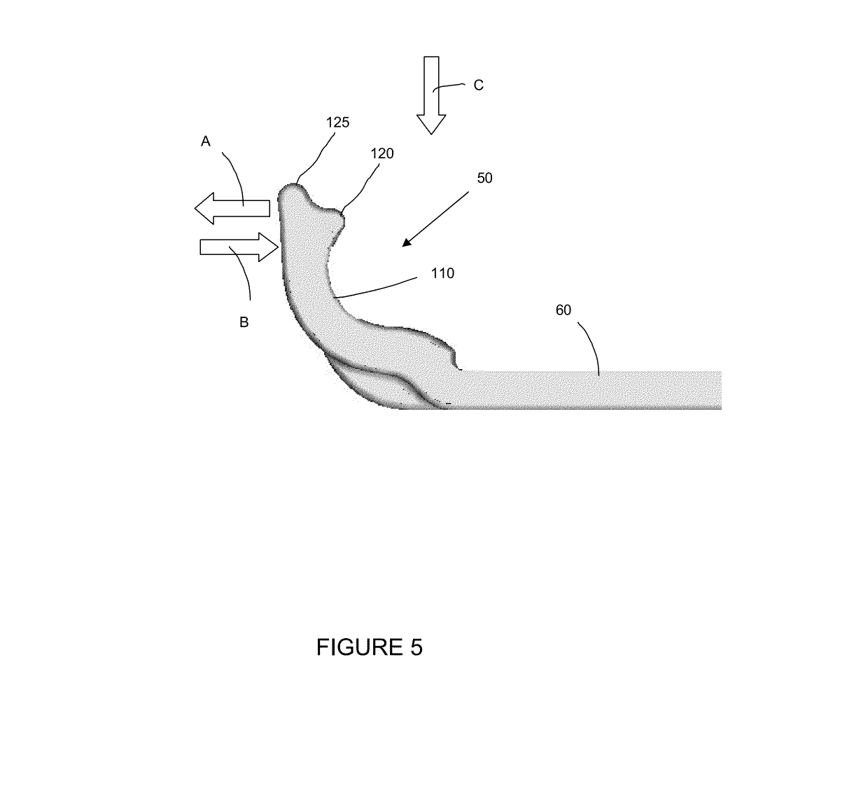

FIG. 5 is a side view of the elastic clip 50 of securing apparatus contact point.

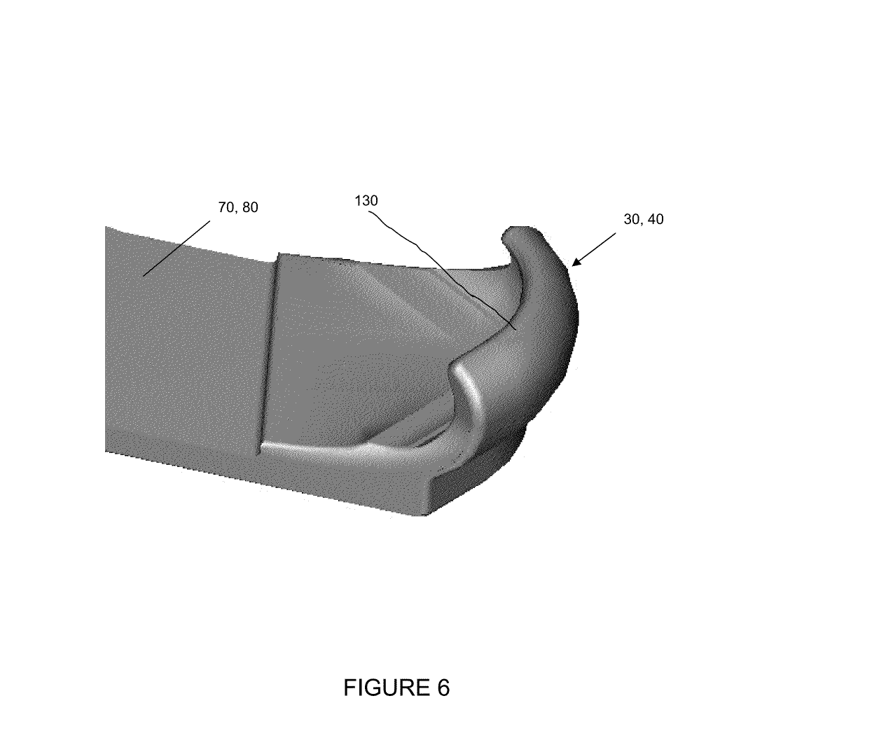

As seen in this Figure, the profile of elastic clip 50 is straight, in order to engage along its entire length with the side of the electronic device 100. This is compared to the curved profile of the corner contact points 30, 40 as illustrated in FIG. 6, which are configured to engage a curved corner or electronic device 100.

Elastic clip 50 is provided with the lip 120 that fits over an edge of electronic device 100, when electronic device 100 is attached to securing apparatus 10. In a preferred embodiment, lip 120 fits over an edge of a protrusion (e.g., a piping) formed on a side surface of electronic device 100. Alternatively, lip 120 can be fit over the top of the case of electronic device 100, engaging the top surface of the device 100. The profile of area 100 is shaped to conform to the profile of the device 100. Although depicted as being curved, it is appreciated that the profile 110 can be altered to better conform to the profile of the edge of device 100. Sharp corners on profile 100 are not preferred to avoid any physical interference when attaching and detaching device 100 to securing apparatus 10.

Elastic clip 50 has a protrusion 125 that enables a user to move the clip 50 in a lateral direction A when attaching and detaching electronic device 100 to securing apparatus 10. In a preferred embodiment, clip 50 has sufficient elasticity such that the user does not have to use protrusion 125 to move clip 50 in the lateral direction A when attaching electronic device 100 to securing apparatus 10. The user simply has to apply a downward pressure to electronic device 100 in direction C to snap the device 100 into clip 50. The rounded end of lip 120 allows the edge of the device 100 to apply the lateral force in direction A, pushing back the clip 50 and allowing the device 100 to be secured in clip 50. Preferably, clip 50 is made of a material of a sufficient thickness, that once the user has applied the downward pressure in direction C, clip 50 will move in lateral direction B due to the elastic “memory” of the material. This “memory” of the material should be sufficient to provide lateral movement in direction B for thousands of cycles of attaching and detaching device 100.

FIG. 6 is a perspective view of one of the corner contact points 30, 40. As seen in this Figure, the profile of these contact points is curved in both the vertical and horizontal directions. These curvatures are designed to conform to the profiles of the corners of electronic device 100. Again, as appreciated by those skilled in the art, the profiles of attachment points 30, 40 can be altered to better conform to the profile of the corners of device 100. Sharp corners on the profiles of attachment points 30, 40 are not preferred in order to avoid any physical interference when attaching and detaching device 100 to securing apparatus 10.

Similar to lip 120 in clip 50, corner contact points 30, 40 have a lip 130 that fits over an edge of electronic device 100, when electronic device 100 is attached to securing apparatus 10. In a preferred embodiment, lip 130 fits over an edge of a protrusion (e.g., a piping) formed on a side surface of electronic device 100. Alternatively, lip 130 can be fit over the top of the case of electronic device 100, engaging the top surface of the device 100.

Unlike clip 50, corner engagement sections 30, 40 do not have any protrusions for use by the operator. In operation, the user fits the two corners of electronic device 100 into the corner sections 30, 40 and then applies the downward pressure to the edge of device 100 near clip 50 in order to attach the device 100 to securing apparatus 10 as described above. In a preferred embodiment, corner contact points 30, 40 do not have the same lateral elasticity as clip 50.

Once engaged in securing apparatus 10, the electronic device 100 remains secured in apparatus 10 by a pressure fit. Unlike many conventional securing devices, securing apparatus 10 does not require any apertures in electronic device 100 into which protrusion of the securing device are mated. This is a significant functional and cost savings advantage of the present invention over conventional devices. The securing apparatus 10 can be used with any electronic device of similar form factor, without any special manufacturing required to conform the electronic device to the securing apparatus (or vice versa).

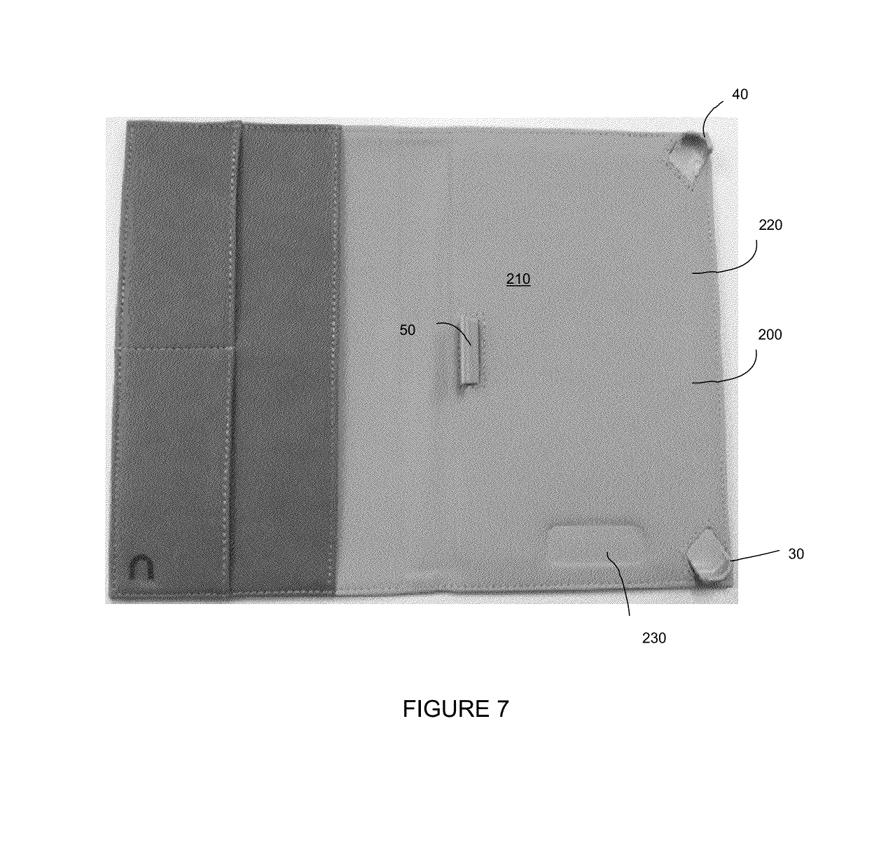

FIG. 7 illustrates the securing apparatus 10 of the present invention embedded in a cover 200 for an electronic device. As seen in this Figure, only the elastic clip 50 and the corner connection points 30, 40 protrude from the surface 210 of the cover 200. Securing apparatus 10 is attached to a supporting panel 220 of cover 200 in a conventional manner, such as by gluing or by mechanical connection. For esthetic purposes and to prevent scratching of the cover of the electronic device, interior surface 210 of the cover 200 is a soft, but durable material such as cloth or leather. An area 230 on cover 200 is provided to allow sound from a speaker in the electronic device to be transmitted through the cover. As seen form the previous Figures, none of the structure of securing apparatus 10 is disposed in this area to block the transmission of the sound.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. An apparatus for securing an electronic device in a cover comprising:
a main body member;
a first contact member extending from the main body member, the first contact member operable to engage a first corner of the electronic device;
a second contact member extending from the main body member, the second contact member operable to engage a second corner of the electronic device;
a third contact member extending from the main body member, the third contact member operable to engage a side of the electronic device opposing the first and second corners.

2. The apparatus according to claim 1, wherein the third contact member further comprises:
a lip operable to engage a surface of the electronic device; and
a protrusion for operation by a user to elastically deform the third contact member when detaching the electronic device from the apparatus.

3. The apparatus according to claim 1, wherein the third contact member is made from a material and has a thickness such that it elastically deforms when a user presses the electronic device into the apparatus.

4. The apparatus according to claim 1, wherein the third contact member elastically deforms when a user presses the electronic device into the apparatus.

5. The apparatus according to claim 4, wherein the third contact member is in a first position without the electronic device attached thereto, and wherein after the elastic deformation due to insertion of the electronic device, the third contact member returns to the first position.

6. The apparatus according to claim 1, wherein the first and second contact members, each further comprise:
a lip operable to engage a surface of the electronic device.

7. The apparatus according to claim 6, wherein the surface of the electronic device is a surface on an edge of the electronic device.

8. The apparatus according to claim 6, wherein the surface of the electronic device is a top surface of the electronic device.

9. The apparatus according to claim 1, further comprising:
web members formed in the main body, the web members providing additional stability to the apparatus.

10. A cover for an electronic device in a cover comprising:
a supporting panel;
a securing apparatus coupled to the supporting panel, the supporting apparatus comprising:
a first contact member operable to engage a first corner of the electronic device;
a second contact member operable to engage a second corner of the electronic device;
a third contact member operable to engage a side of the electronic device opposing the first and second corners.

11. The cover according to claim 10, further comprising:
a surface covering disposed on the supporting panel on top of the securing apparatus, wherein the first, second and third contact members protrude through the surface covering.

12. The cover according to claim 10, wherein the third contact member further comprises:
a lip operable to engage a surface of the electronic device; and
a protrusion for operation by a user to elastically deform the third contact member when detaching the electronic device from the apparatus.

13. The cover according to claim 10, wherein the third contact member elastically deforms when a user presses the electronic device into the securing apparatus.

14. The cover according to claim 10, wherein the first and second contact members, each further comprise:
a lip operable to engage a surface of the electronic device.

15. The cover according to claim 14, wherein the surface of the electronic device is a surface on an edge of the electronic device.

16. The cover according to claim 14, wherein the surface of the electronic device is a top surface of the electronic device.

17. The cover according to claim 10, further comprising:
web members formed in the securing apparatus, the web members providing additional stability to the cover.

18. An apparatus for securing an electronic device in a cover, the electronic device having side edges and a rigid piping disposed along the side edges, the apparatus comprising:
a first contact member operable to engage the rigid piping of the electronic device;
a second contact member operable to engage the rigid piping of the electronic device;
a third contact member operable to engage the rigid piping of the electronic device, wherein the third contact member is elastically deformable to enable attachment and detachment of the electronic device to the apparatus;

19. The apparatus according to claim 18, wherein the electronic device is rectangular and has two long side edges and two short side edges, wherein the first contact member is operable to engage the rigid piping of the electronic device at a first corner between a first long side edge and a first short side edge, wherein the second contact member is operable to engage the rigid piping of the electronic device at a second corner between the first long side edge and a second short side edge and wherein the third contact member is operable to engage the rigid piping of the electronic device at a second long edge opposite the first long edge.

20. The apparatus according to claim 18, wherein the third contact member further comprises:
a lip operable to engage the rigid piping of the electronic device; and
a protrusion for operation by a user to elastically deform the third contact member when detaching the electronic device from the apparatus.
